(19) United States
(12) Patent Application Publication
(10) Pub. No.: US 2007/0122552 A1
(43) Pub. Date: May 31, 2007

(54) COATING DEVICE

(76) Inventor: Pierre CODERRE, Rouyn-Noranda (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/468,493

(22) Filed: Aug. 30, 2006

(30) Foreign Application Priority Data
Nov. 12, 2005 (GB) 0523137.8

(51) Int. Cl. B05D 5/00; B05D 7/00; C23C 18/00

(52) U.S. Cl. 427/282; 427/421.1; 427/429; 427/368

(57) ABSTRACT

A coating device comprises a longitudinal casing having an input end and an output end at opposed ends of a longitudinal direction, a coating liquid source, spray heads positioned inside the casing in a given arrangement and connected to the coating liquid source, so as to produce a spray of the coating liquid, and conveying means in association with the longitudinal casing so as displace an article along the longitudinal direction of the longitudinal casing such that the given arrangement of the spray heads enables to coat three faces of the article with the coating liquid. A method for coating an article is also provided.

### CROSS-REFERENCE TO RELATED APPLICATION

The present patent application claims priority on United Kingdom Patent Application No. 0523137.8, filed on Nov. 12, 2005, by the present applicant.

### BACKGROUND OF THE INVENTION

1. Field of the Invention

The present invention relates to the general field of devices for applying coatings on articles and is particularly concerned with a portable coating device.

2. Background Art

There exists a plurality of situations wherein it is desirable to apply at least one layer of coating to an article in order to protect the latter and/or improve its aesthetical appearance. Various types of coatings including paint, lacquer, enamel, stains or the like are known. In the wood-related industries, staining remains a popular method of coating wood articles since it generally preserves the natural grain of the wood.

Wood stain is applied to wood articles through different methods. When a relatively deep staining is required, allowing the stain to penetrate deeply into or even entirely through the wood article, the staining process is typically performed in an autoclave. The articles to be coated are placed in the autoclave and dipped into a colored stain. The autoclave is then closed and the penetrating staining is started by means of temperature and pressure increases, as is well known in the art. Depending on the type of wood and the thickness of wood article to be stained, penetrating staining can take several hours or even several days.

When only the surface of the article needs to be stained, the staining process is typically performed either by painting or spraying or any other method known in the art. When the required staining needs to be performed at relatively high quality standards, it is common in the trade to use specialized professionals for performing the staining operation. The staining operation often requiring labor-intensive operations performed by specialized professionals can, hence, lead to relatively high staining costs.

Indeed, during a typical staining process, the article being stained must be typically manipulated extensively while taking great care to avoid contacting already stained areas. This may prove particularly difficult in situations wherein the article being stained is a three-dimensional article having surface irregularities such as bent edges, indentations, curved surfaces, protrusions and the like.

In order to circumvent the above-mentioned disadvantages, coating devices using spray heads for spraying fluent coating substances on articles as they are conveyed by a conveyor past the spray heads have been developed. Although at least partially alleviating some of the hereinabove-mentioned drawbacks, such conventional coating devices using conveyors shown in the prior art suffer from numerous drawbacks.

One of these drawbacks relates to the fact that the spray heads are typically not adapted to provide a professional-looking coating finish. Indeed, the coating applied on the articles is often non-uniformly applied, deterring the overall aesthetical aspect of the object and potentially lessening the protection afforded by the coating to the article. This problem is further compounded in situations wherein the article being coated is a three-dimensional article presenting surface irregularities. One of the reasons for the increased difficulty in situations wherein three-dimensional articles having surface irregularities are being coated, is related to the fact that the spray heads are typically not adjustable. Hence, the angular orientation of the surface irregularities with respect to the direction of the spray typically varies. The more the surface varies from an orientation perpendicular to the spray direction, the more difficult it becomes to adequately coat the surface. Also, for curved or angled surfaces, difficulty in coating occurs in part because an angled or curved surface has a greater density of surface area than a flat surface. This means that, as the conveyor moves, the three-dimensional article passes the spray head, the surface area per unit time which passes the spray head is greater for angled or curved surfaces than for flat surfaces. Additionally, some surface irregularities are actually cut-out regions requiring no coating at all.

Also, most conventional coating devices using conveyors only use spray heads and are not provided with suitable means for applying a distributing means such as a paint brush, a foam, a pad or the like on the sprayed surface so as to evenly distribute the coating material once sprayed thereon.

Another drawback associated with conventional coating devices using conveyor for conveying articles past the spray heads relates to the fact that a considerable volume of coating material is often wasted. Indeed, most conventional prior-art coating devices using conveyors are not provided with suitable recycling or recovery means for recovering or recycling unused coating material dispended through the spray heads during operation.

Furthermore, most conventional coating devices using conveyors are not well adapted to be easily cleaned between uses and are typically mechanically complex requiring intensive maintenance and frequent repair. Still furthermore, most conventional coating devices using conveyors are generally cumbersome and are not well adapted to be portable so as to be easily transported from one work site to another and conveniently stored when not in use.

### SUMMARY OF INVENTION

It is therefore a general object of the present invention to provide an improved coating device.

Therefore, in accordance with the present invention, there is provided a coating device comprising: a longitudinal casing having an input end and an output end at opposed ends of a longitudinal direction; a coating liquid source; spray heads positioned inside the casing in a given arrangement and connected to the coating liquid source, so as to produce a spray of the coating liquid; and conveying means in association with the longitudinal casing so as displace an article along the longitudinal direction of the longitudinal casing such that the given arrangement of the spray heads enables to coat three faces of the article with the coating liquid.

Further in accordance with the present invention, there is provided a method for coating an article by displacing the article in a casing, comprising the steps of: inletting an article in a casing; spraying a coating liquid onto there faces of the article; wiping excess coating liquid off the article; brushing coating liquid into the article; and outletting the article from the casing; whereby the article is coated.

### BRIEF DESCRIPTION OF THE DRAWINGS

An embodiment of the present invention will now be disclosed, by way of example, in reference to the following drawings, in which:

FIG. 1A is a partial longitudinal cross-sectional view with sections taken out, illustrating part of a coating device in accordance with an embodiment of the present invention;

FIG. 1B is a schematic longitudinal view of the coating device of FIG. 1A;

FIG. 2 is a schematic partial longitudinal top cross-sectional view, illustrating part of the coating device shown in FIG. 1;

FIG. 3 is a partial perspective view with sections taken out, illustrating part of the adjustable spraying system incorporated in the device shown in FIGS. 1 and 2;

FIG. 4 is a partial perspective view with sections taken out, illustrating part of an adjustable brush-mounting assembly incorporated in the device shown in FIGS. 1 and 2;

FIG. 5 is a partial perspective view with sections taken out, illustrating part of a pad supporting component incorporated in the device shown in FIGS. 1 and 2;

FIG. 6 is a partial perspective view with sections taken out, illustrating part of an overhead pad supporting and tensioning component incorporated in the device shown in FIGS. 1 and 2;

FIG. 7 is a partial perspective view with sections taken out, illustrating part of a pad-mounting component;

FIG. 8 is a partial perspective view with sections taken out, illustrating part of a brush-mounting component; and

FIG. 9, in a partial perspective view with sections taken out, illustrating part of a lateral pad-supporting component.

### DESCRIPTION OF THE PREFERRED EMBODIMENTS

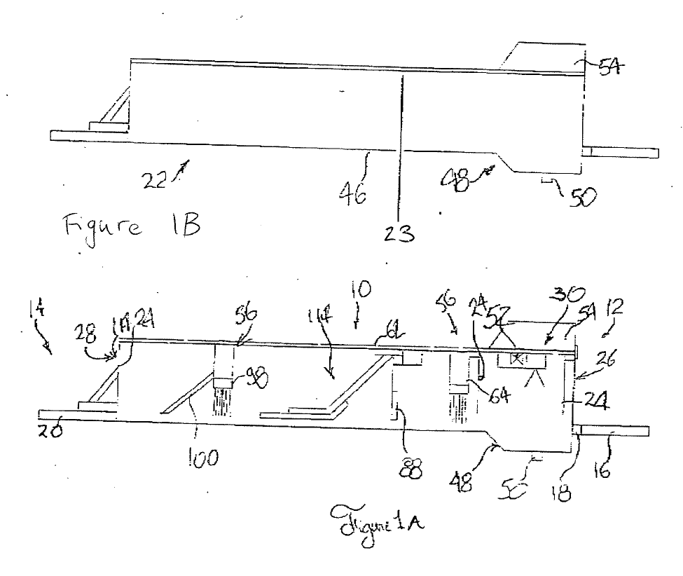

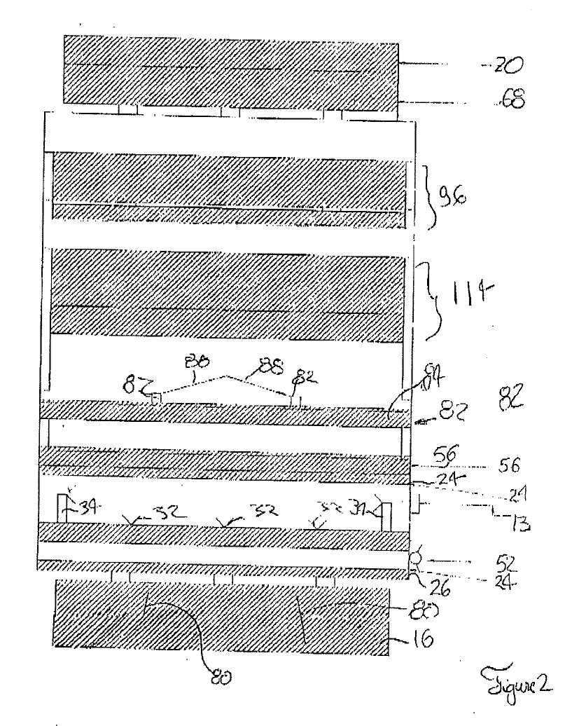

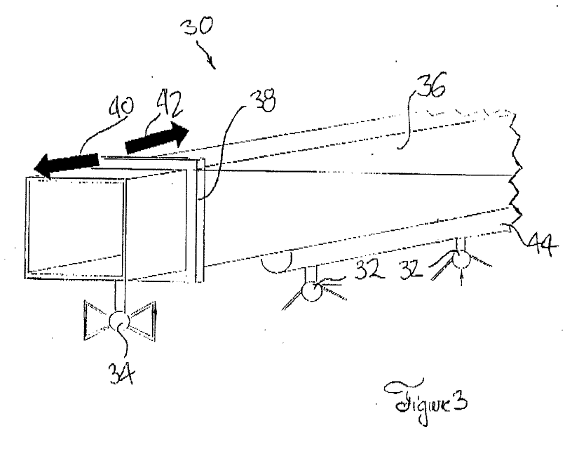

Referring to FIG. 1 (i.e., FIGS. 1A and 1B), there is shown in a longitudinal side cross-sectional view with sections taken out, part of a coating device 10 in accordance with an embodiment of the present invention. The device 10 typically has a generally elongated configuration defining a first or input end 12 and a generally opposed second or output end 14. The device 10 includes a frame schematically illustrated, on which several components are mounted. The frame is preferably collapsible so as to minimize the required space for transportation and storage, and is preferably mounted on wheels, such as caster-type wheels or the like for facilitating transportation thereof.

The device 10 typically includes an input platform 16 leading to a conveyor means 18 for allowing an intended user to manually, mechanically or otherwise feed articles to be coated to the device 10. The conveyor means 18 may take any suitable form, such as a conventional belt-type conveyor or the like. A conveyor means 18 is intended to convey the articles through the device 10 to an outlet platform 20 wherein the articles once coated may be removed from the device 10 for further processing, storage or any other use. A shell component 22 is typically mounted over the frame of the device 10 so as to extend between the inlet and outlet platforms 16,20 in order to form a generally seal-type enclosure generally encompassing the frame of the device 10. The output platform 20 may be optionally cushioned or otherwise modified to provide a suitable support for the coated articles. The shell component 22 is typically provided with a sealing lining 23 at strategic locations for maintaining a seal-type enclosure preventing fluent coating materials from flowing out of the device 10. The device 10 is also preferably provided with sealing curtains 24 positioned adjacent to both the input and output apertures 26, 28 of the device 10 for maintaining a substantially seal-tight enclosure while allowing ingress and egress of the articles being coated into and out of the input and output apertures 26, 28. The sealing curtains 24 are preferably made out of a generally flexible material such as a suitable elastomeric resin.

The device 10 is also provided with a spray means for spraying articles with a coating material. The spray means typically includes a spray assembly 30 generally located adjacent to a top wall of the device 10 and adjacent to the input aperture 26. As illustrated more specifically in FIG. 3, the spray assembly 30 typically includes both fixed spray heads 32 and adjustable spray heads 34 both attached to a spray head supporting beam 36. The adjustable spray heads 34 are typically attached to slidable mounting frame 38 slidably mounted on the spray head mounting beam 36 for slidable movement therealong as indicated by arrows 40, 42.

Both the fixed and adjustable spray heads 32, 34 are typically hydraulically connected to a suitable pump 52 through suitable duct means including a fixed duct 44 anchored to the spray head supporting beam 36. The pump 52 is, in turn, hydraulically coupled to a liquid container 54 typically mounted on top of the device 10.

The frame of the device 10 and a bottom wall 46 of the shell component 22 typically define a recuperation basin 48 for recuperating fluent liquid material within the device 10. The basin 48 is typically provided with a drain 50 for facilitating maintenance thereof. The drain 50 is provided with suitable filtering screens for filtering out unwanted particles and allowing at least part of the recuperated liquid within the basin 48 to be recycled towards the spray heads 32,34 through the use of the pump 52. Both the spray heads 32 and 34 are typically provided with spray adjustment means for adjusting the pattern of the spray emanating therefrom.

The coating device 10 is typically further provided with at least one and preferably two coating-applying brushes 56 having suitable brush bristles 58 extending from a brush head 60. The brush 56 is typically mounted to a top wall 62 of the device 10 using a brush-mounting component 64. The brush-mounting component 64 includes generally L-shaped retaining flanges 66 extending therefrom for slidably receiving the brush head 60. The brush component 56 may be sectioned so as to allow adjustment of the length of the brush component 56 depending on the configuration and size of the article being coated.

As shown more specifically in FIG. 7, wiping pads 68, a wiping component 70 mounted to a pad head 72. The wiping pads 68 are typically attachable to pad-supporting components 74 having generally L-shaped pad-supporting flanges 78 by slidable engagement therewith, as indicated by arrow 76.

Again, the wiping pads 68 may be segmented so as to allow for adjustment of the length of the wiping area depending on the configuration and size of the article being coated. When relatively small articles are being coated, the length of both the brushes and pads may be shortened by using only a section thereof. In such situations, guiding walls 80 positioned adjacent to the inlet platform 16 allow for proper positioning and centering of the smaller articles.

Wiping pads 78 may also be mounted within the device 10 so as to wipe the lateral surfaces of articles. FIG. 9 illustrates a lateral pad-supporting assembly 82 for positioning wiping pads, such as wiping pads 68, in a lateral relationship relative to articles being conveyed on the conveying means. The assembly 82 includes a supporting post 84 having arms 86 extending downwardly therefrom. Mounting brackets 88 including L-shaped flanges 90 are hingedly mounted to the arms 86 by hinge components 92. The L-shaped flanges 90 are configured and sized for slidably receiving the wipe pad heads 72, such as shown in FIG. 7. As the articles are conveyed by the conveyor means, the articles push on the wiping pads 68 hence pivoting the panels 88 according to arrows 94. Biasing means such as springs are provided for biasing the panels or brackets 88 back towards their initial position, wherein they lie in a generally parallel relationship relative to the supporting rod 84.

FIG. 5 illustrates a mounting assembly 96 for mounting wiping pads 68 in an overlying relationship relative to the articles being coated. The assembly 96 includes a supporting rod 98 and a mounting bracket 100 hingedly mounted thereto by hinge components 110. Similarly, the mounting bracket 100 is provided with L-shaped flanges 112 for slidably receiving wipe pad heads 72. The hinge components 110 are provided with biasing means for biasing the latter towards the initial configuration wherein they lie in a generally perpendicular relationship relative to the support beams 98.

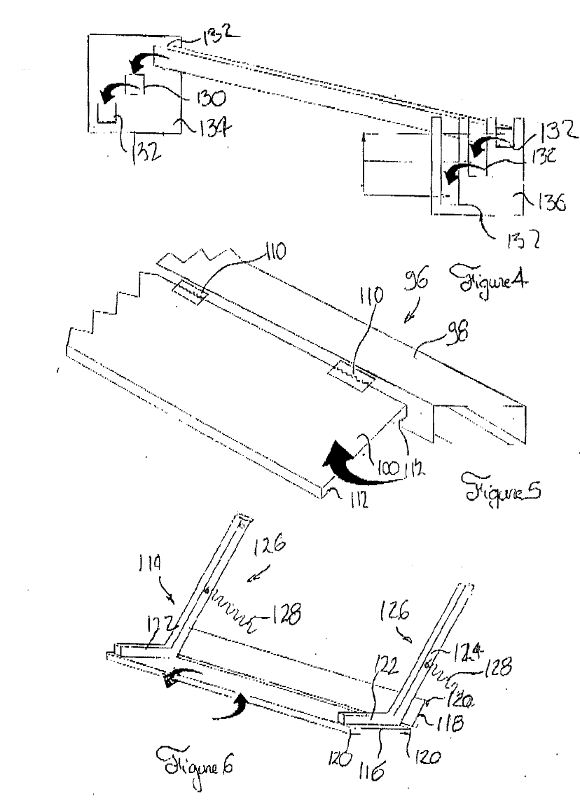

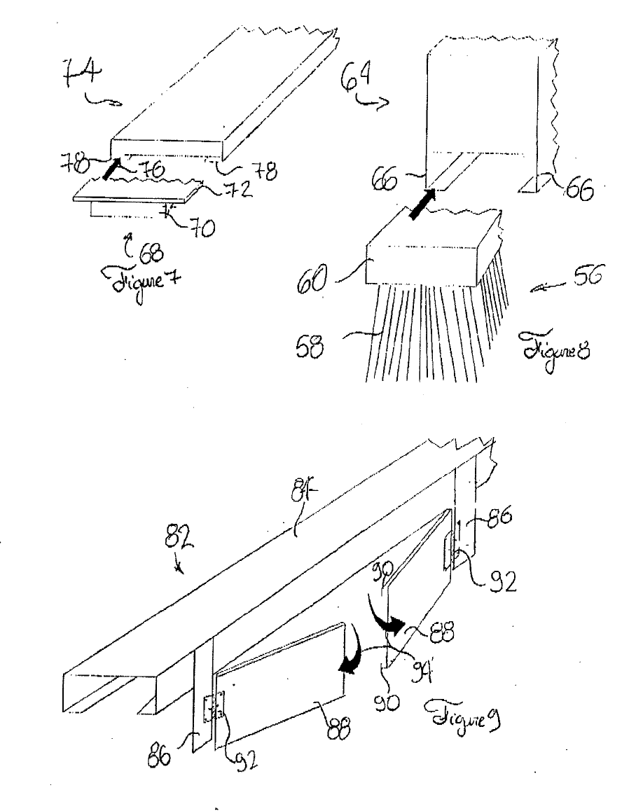

As illustrated in FIG. 6, wiping pads 68 may also be mounted to a tensioned mounting assembly 114. The tensioned mounting assembly 114 pivotally includes first and second mounting brackets 116, 118 having L-shaped flanges 120 for slidably receiving pad heads 72. The mounting brackets 116, 118 are respectively attached to a first and second arm 122, 124 part of generally L-shaped and spaced-apart mounting legs 126. The mounting legs 126 are provided with biasing means such as helicoidal-type springs 128 attached thereto for biasing mounting legs 126 towards an initial configuration wherein the arms 122 extend in a generally horizontal configuration. The arms 124 are pivotally mounted to the walls of the device 10 for pivotal movement relative thereto. It should be understood that the mounting brackets shown throughout the figures may receive either wiping pads or brushes 68, 56 and that the latter may be interchanged within the device 10 without departing from the scope of the present invention. In other words, various combinations of wiping pads and brushes 68, 56 forming different configurations may be used without departing from the scope of the present invention.

The height of the supporting assembly relative to the conveying means may be adjusted depending on the configuration and size of the article being coated. For example, the supporting beams 64, 74, 84 and 98 may be mounted at longitudinal ends thereof into apertures 130 and recesses 132 formed at different heights within corresponding supporting panels 134, 136 located on each lateral side of the device 10 therealong.

Operation of the device 10 may be accomplished either manually or automatically using suitable control means including a control panel 138 located outside the device 10.

The coating device 10 allows for the application of fluent coating material of various sorts on various types of three-dimensional objects. The coating device 10 allows for a generally constant and uniformed coating to be performed on various objects even when the latter present a certain degree of surface irregularities.

Also, the coating device 10 allows coating to be applied to various types of articles while reducing the required manipulation of such articles through a set of quick and ergonomic steps without requiring skilled or trained work persons.

Furthermore, the coating device 10 is designed so as to reduce the wastage of coating material and allow recycling of at least a portion of the unused coating material dispensed during operation of the device. Also, the device 10 is designed so as to be easily cleaned, serviced and repaired. Still furthermore, the device 10 is designed so as to be generally reliable, long-lasting and cost-efficient.

1. A coating device comprising:
a longitudinal casing having an input end and an output end at opposed ends of a longitudinal direction;
a coating liquid source;
spray heads positioned inside the casing in a given arrangement and connected to the coating liquid source, so as to produce a spray of the coating liquid; and
conveying means in association with the longitudinal casing so as displace an article along the longitudinal direction of the longitudinal casing such that the given arrangement of the spray heads enables to coat three faces of the article with the coating liquid.

2. The coating device of claim 1, wherein a first set of the spray heads are positioned on a top interior surface of the casing and a second set of the spray heads are positioned on a lateral interior surface of the casing.

3. The coating device of claim 2, wherein the spray heads of the second set are translatable in a direction generally transverse to the longitudinal direction as a function of the geometry of the article to coat.

4. The coating device of claim 1, further comprising pads positioned downstream of the spray heads, so as to wipe excess coating liquid off the article.

5. The coating device of claim 4, further comprising brushes positioned downstream of the pads, so as to brush coating liquid into the article.

6. The coating device of claim 4, wherein the pads are provided on biasing mechanisms so as to be biased against the articles moving in the casing from the input end to the output end.

7. The coating device of claim 5, wherein the brushes are provided on biasing mechanisms so as to be biased against the articles moving in the casing from the input end to the output end.

8. The coating device of claim 1, wherein the casing has a basin so as to recuperate excess coating liquid from the spray heads.

9. The coating device of claim 8, wherein the coating liquid source is connected to the basin so as to reuse the excess coating liquid.

10. A method for coating an article by displacing the article in a casing, comprising the steps of:
inletting an article in a casing;
spraying a coating liquid onto there faces of the article;
wiping excess coating liquid off the article;
brushing coating liquid into the article; and
outletting the article from the casing;
whereby the article is coated.

11. The method according to claim 10, wherein the step of wiping excess coating liquid is performed by biasing pads against the article being displaced in the casing.

12. The method according to claim 10, wherein the step of brushing coating liquid is performed by biasing brushes against the article being displaced in the casing.
